(19) United States
(12) Patent Application Publication
(10) Pub. No.: US 2021/0109365 A1
(43) Pub. Date: Apr. 15, 2021

(54) WAVEGUIDE ELEMENT

(71) Applicant: DISPELIX OY, Espoo (FI)

(72) Inventors: Kasimir BLOMSTEDT, Espoo (FI); Ismo VARTIAINEN, Espoo (FI)

(73) Assignee: DISPELIX OY, Espoo (FI)

(21) Appl. No.: 17/041,286

(22) PCT Filed: Mar. 4, 2019
(86) PCT No.: PCT/FI2019/050172

§ 371 Date: Sep. 24, 2020

(30) Foreign Application Priority Data
Mar. 28, 2018 (FI) 20185296

(51) Int. Cl. G02B 27/42; F21V 8/00

(52) U.S. Cl. CPC G02B 27/4233; G02B 6/0036; G02B 6/0016

(57) ABSTRACT

The invention provides a waveguide element comprising a waveguide (100) capable of guiding light rays in two dimensions via total internal reflections, and a diffractive optical element (DOE) (120) arranged on or within the waveguide (100), wherein the diffractive optical element (120) is adapted to allow propagation of light rays inside the waveguide (100) along the two dimensions so that the light rays can propagate at least from one first location (140) of the diffractive optical element (120) to at least one second location (150) of the DOE (120) along different routes (160A, 160B) having the same geometrical optical path length. The DOE (120) is further adapted so that at least for one wavelength range the difference in physical optical path lengths for light rays having propagated along the different routes (160A, 160B) is longer than the coherence length, so that the rays sum incoherently at the second location (150).

### FIELD OF THE INVENTION

The invention relates to waveguide-based display elements. In particular, the invention relates to a waveguide comprising a novel type of diffractive optical element. The invention can be used in modern personal displays, such as Head-mounted displays (HMDs) and head-up displays (HUDs).

### BACKGROUND OF THE INVENTION

HMDs and HUDs can be implemented using waveguides. Light can be coupled to waveguide, redirected therein or coupled out of the waveguide and to a user's eye using diffraction gratings. Exit pupil expansion can be carried out in the waveguide using grating at which the light rays bounce in two dimensions, thus effectively spreading the light field to a larger area. At each location of the grating, light waves having travelled along different paths are summed. Due to manufacturing-related inaccuracies, waves, whose modelled optical path difference is zero, have actually experienced different phase shifts, making the waves partially coherent. In the design of such EPE gratings, for example, one problem relates to computational challenges induced due to the partial incoherence. That is, (almost) fully coherent waves and (almost) fully incoherent waves are relatively easy to sum, but summing of partially coherent waves, whose degree of coherence is even not exactly known, causes problems. These design- and computation-related problems eventually lead to lower-quality waveguide elements and waveguide display devices. Partially coherent waves are of concern particularly when the light source itself is nearly coherent (laser light).

### SUMMARY OF THE INVENTION

It is an aim of the invention to address the abovementioned problem.

The aim is achieved by the invention as defined in the independent claims.

According to one aspect, the invention provides a waveguide element comprising a waveguide capable of guiding light rays in two dimensions via total internal reflections, and a diffractive optical element (DOE) arranged on or within the waveguide, wherein the DOE is adapted to allow propagation of light rays inside the waveguide along the two dimensions so that the light rays can propagate at least from one first location of the diffractive optical element to at least one second location of the DOE along different routes having the same geometrical optical path length. The DOE is further adapted so that at least for one wavelength range the difference in physical optical path lengths for light rays having propagated along the different routes is longer than the coherence length, so that the rays sum incoherently at the second location.

The invention offers significant benefits. Most of all, the invention solves the partial coherence problem at least for some wavelengths and propagation routes in the waveguide and therefore mitigates both coherence-related computational and practical optical quality problems.

The dependent claims are directed to selected embodiments of the invention.

Next, embodiments of the invention and advantages thereof are discussed in more detail with reference to the attached drawings.

### BRIEF DESCRIPTION OF THE DRAWINGS

FIG. 1 shows a top view of a two-dimensional waveguide element having a DOE in accordance with the invention.

FIG. 2 shows a schematic cross-sectional view of a waveguide element.

FIG. 3 illustrates the graph of the phase as a function of the wavenumber together with a linear approximation thereof.

FIGS. 4A and 4B show side and top views, respectively, of a microstructure of a single period of a large-period grating.

### DETAILED DESCRIPTION OF EMBODIMENTS

### Definitions

“Phase Function” Denotes the Phase Distribution as a Function of the Wavenumber within a Wavelength (Wavenumber) Range of Interest.

“Geometrical optical path length” is herein defined as the distance travelled in waveguide multiplied by real part of the refractive index of the waveguide material for the studied wavelength.

“Physical optical path length” is defined as the slope of the linear approximation to the phase function at the wavelengths of interest. That is, as the ratio between the phase change and the wavenumber difference. We observe that this approximation is used only to simplify the discussion and does not imply that the phase function is or should be linear or nearly so.

The term “incoherent” and “fully incoherent” describes the relationship between two rays whose path length difference exceeds the coherence length in the waveguide material concerned. Specifically, if the slope of the linear approximation to the difference of the phase functions of two rays exceeds the coherence length, these rays are incoherent.

### Description of Selected Embodiments

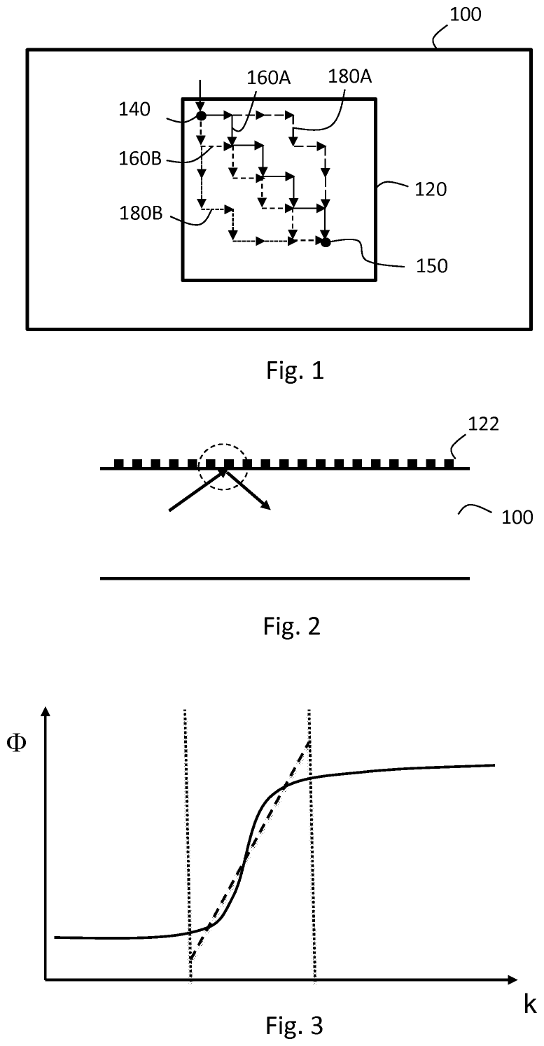

FIG. 1 shows a waveguide element comprising a waveguide 100 capable of guiding light rays in two dimensions via total internal reflections. There is provided on or within the waveguide 100 a DOE 120. The DOE is adapted to spread light rays inside the waveguide along the two dimensions, for example along first and second routes 160A, 1608 between a first location 140 and a second location 150 thereof. The routes 160A, 1608 have the same geometrical optical path length. Each arrow represents a single “hop” of rays via total internal reflection in the waveguide from the DOE back to the DOE. The DOE has a suitable diffractive structure so as to turn/split the rays in a predefined manner so as to spread the rays within the DOE.

The structure of the DOE 120 is configured to cause a difference in physical optical path lengths for light rays having propagated along the different routes 160A, 1608, which is longer than the coherence length, so that the rays sum incoherently at the second location, at least for some wavelength range. With conventional DOEs, the phase function is not controlled per se and the majority of the phase function along any path is due to manufacturing inaccuracies and is thereby uncontrollable. In particular, the phase functions thus induced cause phase function differences for equal geometrical optical path lengths that invalidate coherent summation, but do not have (approximate) slopes large enough to exceed that of the linear phase function corresponding to the coherence length.

In some embodiments, the same holds for more than two routes, i.e. additionally for example for third and fourth routes 180A, 1808 which have the same geometrical optical path length, that, may be the same or different from that of the first and second routes 160A, 160B.

In some embodiments, and usually, there are several location pairs (corresponding to the pair 140/150) for which at least some of the abovementioned conditions hold. Thus, light rays can propagate from several first locations of the DOE to several second locations of the DOE along several different routes having the same route lengths. For at least some of said several different routes, the DOE is adapted to cause said difference in physical optical path lengths. In some embodiments, the DOE is adapted to cause said difference in the physical optical path lengths for all of the several different routes.

FIG. 2 shows schematically a single interaction of a ray with the DOE 122 at a specific location of the waveguide 100. At the dashed circle, the DOE microstructure (not shown detail) is such that a predefined significant phase shift occurs. Thus, the incoming ray has a different phase than the light ray having diffracted by the DOE. This effect is preferably arranged to take place on most or all locations of the DOE. The phase shift efficiency can be wavelength- and/or angle dependent.

To achieve a route-dependent phase shift, i.e. a shift which is generally different for different routes, the DOE comprises several different areas having different grating properties.

FIG. 3 illustrates an exemplary typical phase shift curve of a grating structure usable for the purposes of the invention. It can be seen that for at least some wave vector values, and therefore for at least some wavelengths, a large phase shift is caused. The slope describes an approximate of the phase shift between the dotted vertical lines denoting the wavenumber (wavelength) region of interest.

In some embodiments, the DOE comprises one or more leaky mode grating areas, which participate in the generation of the phase difference.

In some embodiments, the DOE comprises one or more resonant grating areas, which participate in the generation of the phase difference.

Detailed discussion of the type of gratings capable of causing the required phase shift can be found in Vartiainen I. et al, Depolarization of quasi-monochromatic light by thin resonant gratings, OPTICS LETTERS/Vol. 34, No. 11/Jun. 1, 2009.

In further embodiments, the DOE is adapted to essentially maintain the intensity of light when the light rays hit the DOE, irrespective of wavelength.

In practice, one can implement the present DOEs at least to feasible extent using conventional gratings having a period in the order of the visible spectrum, that is, less than 1 μm, typically less than 700 nm. The DOE may comprise several grating areas having different properties.

In some preferred embodiments, the period of the grating(s) is larger than the maximum visible wavelength in at least one, typically both dimensions thereof. In such grating, each period of the grating comprises a two-dimensional non-periodic microstructure pattern which repeats from period to period within a single grating area.

In this case, there is in the DOE at least one area comprising a grating which has a substantially larger period than the wavelength of visible light. In particular, the period is at least fivefold compared to the maximum visible light wavelength (700 nm) and typically 5 Jim or more, for example 5-75 Jim, and usually less than 1000 μm. Such gratings are still diffractive for incident light beams that are larger than the period, as the case typically is in display applications, but their diffraction is not limited to conventional few diffraction orders (+/−1 and 0). Such gratings give additional freedoms of design which can be used to implement the desired phase shift behavior all over the DOE.

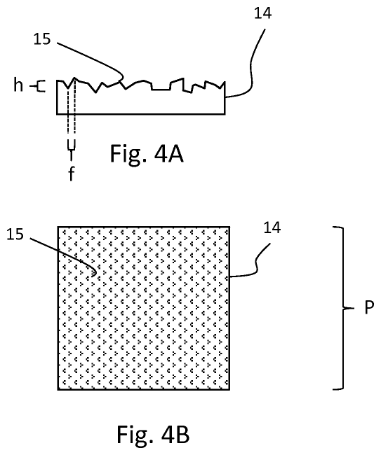

FIGS. 4A and 4B show an exemplary unit element 14 having a lateral dimension corresponding to the large period P in cross-sectional side view and top view. The unit element has a surface profile 15, which is essentially non-periodic, in order not to decrease the effective period of the grating. The structure is composed of microfeatures, which have the average size f and maximum height of h. Herein, f is defined as the average distance from the bottom of a valley to the top of the neighboring peak.

The feature size f can be e.g. 10-700 nm and maximum height h e.g. 20-500 nm.

For more detailed description of the implementation of large-period gratings suitable for the present use, the still non-published Finnish patent application No. 20176157 is referred to.

1. A waveguide element comprising:
a waveguide capable of guiding light rays in two dimensions via total internal reflections, and
a diffractive optical element (DOE) arranged on or within the waveguide, wherein:
the DOE is adapted to allow propagation of light rays inside the waveguide along said two dimensions so that the light rays can propagate at least from one first location of the DOE to at least one second location of the DOE along different routes having the same geometrical optical path length, and
the DOE is further adapted so that at least for one wavelength range the difference in physical optical path lengths, defined as the slope of linear approximation to the phase function at the wavelengths of the rays, for light rays having propagated along said different routes is longer than the coherence length, so that the rays sum incoherently at the second location.

2. The waveguide element according to claim 1, wherein:
the light rays can propagate from several first locations of the DOE to several second locations of the DOE along several different routes having the same geometrical optical path lengths, and
for at least some of said several different routes, the DOE is adapted to cause said difference in physical optical path lengths.

3. The waveguide element according to claim 2, wherein the DOE is adapted to cause said difference in physical optical path lengths for all of said several different routes.

4. The waveguide element according to claim 1, wherein the DOE is adapted, on at least some locations thereof, to cause for said wavelengths a significant phase change when the light rays hit the DOE.

5. The waveguide element according to claim 4, wherein the DOE is adapted, on most locations thereof, to cause for said wavelengths a significant phase change when the light rays hit the DOE.

6. The waveguide element according to claim 4, wherein the DOE is adapted to maintain the intensity of light when the light rays hit the DOE.

7. The waveguide element according to claim 1, wherein the DOE comprises a plurality of neighboring grating areas with different grating properties so as to cause said difference in the physical optical path lengths of the different routes.

8. The waveguide element according to claim 1, wherein the DOE comprises one or more leaky mode grating areas, which participate in the generation of the difference in the physical optical path lengths.

9. The waveguide element according to claim 1, wherein the DOE comprises one or more resonant grating areas, which participate in the generation of the difference in the physical optical path lengths.

10. The waveguide element according to claim 1, wherein the period of at least some portions of the DOE is in the range of 5 μm or more.

11. The waveguide element according to claim 10, wherein each period of said portions of the DOE comprise a non-periodic microstructure pattern which repeats from period to period.

12. The waveguide element according to claim 2, wherein the DOE is adapted, on at least some locations thereof, to cause for said wavelengths a significant phase change when the light rays hit the DOE.

13. The waveguide element according to claim 12, wherein the DOE is adapted to maintain the intensity of light when the light rays hit the DOE.

14. The waveguide element according to claim 12, wherein the DOE is adapted, on most locations thereof, to cause for said wavelengths a significant phase change when the light rays hit the DOE.

15. The waveguide element according to claim 14, wherein the DOE is adapted to maintain the intensity of light when the light rays hit the DOE.

16. The waveguide element according to claim 3, wherein the DOE is adapted, on at least some locations thereof, to cause for said wavelengths a significant phase change when the light rays hit the DOE.

17. The waveguide element according to claim 16, wherein the DOE is adapted to maintain the intensity of light when the light rays hit the DOE.

18. The waveguide element according to claim 17, wherein the DOE is adapted, on most locations thereof, to cause for said wavelengths a significant phase change when the light rays hit the DOE.

19. The waveguide element according to claim 18, wherein the DOE is adapted to maintain the intensity of light when the light rays hit the DOE.

20. The waveguide element according to claim 2, wherein the DOE comprises a plurality of neighboring grating areas with different grating properties so as to cause said difference in the physical optical path lengths of the different routes.
